(19) United States
(12) Patent Application Publication
(10) Pub. No.: US 2018/0163717 A1
(43) Pub. Date: Jun. 14, 2018

(54) HIGH-PRESSURE PLUNGER PUMP AND METHOD FOR THE FUNCTIONAL INTERRUPTION OF A FLUID FLOW

(71) Applicant: HAMMELMANN GMBH, Oelde (DE)

(72) Inventor: Michael JARCHAU, Oelde (DE)

(21) Appl. No.: 15/839,492

(22) Filed: Dec. 12, 2017

(30) Foreign Application Priority Data
Dec. 14, 2016 (DE) 10 2016 124422.8

(51) Int. Cl. F04B 49/24; F04B 53/10; F02M 59/44

(52) U.S. Cl. CPC F04B 49/246; F04B 53/109; F04B 2201/06012; F02M 59/442; F04B 53/1087

(57) ABSTRACT

A high pressure plunger pump, having at least one plunger arrangement which comprises a working space connected to a valve seat suction line and a valve seat pressure line, in which a plunger is arranged in an axially reciprocable manner, wherein the valve seat pressure line is closeable by a pressure valve and the valve seat suction line by a suction valve, and the suction valve can be kept in an open position in a controlled manner as required by means of a counter-pressure device, is designed so that the counter-pressure device has a supply line via which a control fluid can be guided to the suction valve for keeping the suction valve open, wherein a low-pressure pump is connected to the supply line for generating pressure of the control fluid.

### CROSS-REFERENCE TO RELATED APPLICATIONS

This application claims priority to German Patent Application No. 10-2016-124422.8, filed on Dec. 14, 2016, which is herein incorporated by reference in its entirety.

### BACKGROUND AND SUMMARY OF THE DISCLOSURE

The present disclosure relates to a high-pressure plunger pump according to the preamble of claim 1 and a method for the functional interruption of a fluid flow.

High-pressure plunger pumps are used for the partial processing of a large variety of materials, e.g. for roughening metals, wherein, for this purpose, a working pressure of up to about 4000 bar is generated by means of the high-pressure plunger pump.

The main components of such a high-pressure plunger pump are an oscillating drivable plunger, which displaces a sucked liquid volume in the working space of the pump, a suction and an outlet valve, which control the liquid inflow and the liquid outflow, and a drive device which generates an oscillating motion.

Usually, for driving such high-pressure plunger pumps, rotational drives are used, in particular electric motors or internal combustion engines, wherein the rotational movement is converted by a mechanical or a hydraulic conversion into an oscillating motion.

In order to compensate for dynamic forces, in particular to reduce a pulsating conveying flow, several plunger arrangements are operated in parallel, each with an oscillating plunger as well as a suction and pressure valve. In this case, a pressure line leading through the pressure valve to a hydraulic consumer, e.g. a nozzle, can be closed by the pressure valve and a valve seat suction line by the suction valve.

For example, for the partial roughening of a metallic workpiece, as mentioned above by way of example, the fluid flow must be interrupted for a predetermined time within which the workpiece is moved relative to the nozzle.

Various design solutions are known from the prior art for this purpose, for example those which act mechanically on the suction valve in such a way that it remains in a controlled manner in an open position for the predetermined time, so that the working space is exposed to the suction side and no sufficient pressure is generated to open the normally spring-loaded pressure valve.

For example, reference is made to DE 23 24 746 A with respect to the prior art, in which a rod guided in the valve seat suction line and in a channel adjoining a suction chamber is proposed as a counter-pressure device for functionally interrupting the pressurized fluid flow, said rod being actuatable by means of a magnet to keep the suction valve in an open position.

Both from the manufacturing side as well as in terms of service life, this known high-pressure plunger pump is associated with considerable disadvantages that does not allow an optimized use.

The function-related frequent switching cycles, as are mandatory in such use, lead to high wear of both the magnet and the rod itself, so that relatively frequent, repair-related operational interruptions are the result.

In addition, the placement of the rod or its necessary axial mobility requires appropriate sealing measures of the channel relative to the suction chamber, which on the one hand requires a corresponding manufacturing effort and on the other hand also does not meet the requirements in terms of service life.

This applies equally to a construction disclosed in EP 1 998 045 A1. For keeping the suction valve in an open position, i.e. for lifting a suction valve, the arrangement of pressure plungers which act on the suction valve is proposed in this literature.

From DE 699 19 567 T2 a non-generic fuel injector device is known, having an injection valve, which interrupts a conveying fluid in the form of fuel in the cycle of an internal combustion engine and varies said fluid, depending on the load of the engine. For this purpose, a booster plunger for the actuation and a valve needle as a closing member are required, for the actuation of which an actuating fluid is used which differs from the conveying fluid.

The present disclosure is directed to a high-pressure plunger pump of the generic type that may be easier to produce and may have an increased service life.

While in the references described above, in which the counter-pressure device, with which the suction valve is kept open as needed in a controlled manner, is effective in a purely mechanical manner by the aforementioned solenoid-operated rod or by the pressure plunger, the counter-pressure on the suction valve is achieved purely hydraulically for its lifting by a control fluid, even with a pressure stroke of associated plunger, which preferably similarly corresponds to the pressure fluid, usually water.

According to the high-pressure plunger pump according to the present disclosure, the counter-pressure device has a supply line via which the fluid is passed directly to the suction valve with low pressure, wherein a low-pressure pump is connected to the supply line for generating the pressure of the control fluid, which is in operative connection with a control valve, in the closed position of which the suction valve is raised or remains in the open position, and the counter-pressure device is non-functional during opening, so that the suction valve is ready for use.

In this case, the actuation of the control valve occurs by means of a controller, which is correspondingly programmable, depending on the desired pattern of the workpiece to be machined.

To interrupt the fluid flow, the suction valves of all plunger arrangements of a high-pressure plunger pump are actuated simultaneously, which takes place via the common control valve or the common low-pressure pump.

In an embodiment, the supply line for the control fluid is introduced into a valve seat ring, and opens into a control channel in which a pin of the suction valve is guided, said pin acting in the manner of a plunger and being connected to a valve cone of the control valve.

Since the counter-pressure device now essentially manages without mechanically acting components, the invention leads to an optimization of the manufacturing costs as well as to a significant extension of the service life of the high-pressure plunger pump.

This also contributes to the fact that hermetic seals of the counter-pressure device relative to the working space can be completely dispensed with, in particular, since, as mentioned, the same type of pressurized fluid is used as the control fluid. These are preferably drawn from a common fluid source.

While the suction valve is open to interrupt the fluid flow, the pressure valve is closed, as well as a shut-off valve associated with the hydraulic consumer, so that the working pressure in the pressure line remains constantly high during the functional interruption of the fluid flow. It follows that when closing the suction valve and opening the pressure valve and the shut-off valve associated with the hydraulic consumer, the working pressure is available immediately.

As in the case of the methods known from the references discussed above, a threshold stress which impairs the service life of the components involved also does not occur in the new method.

### BRIEF DESCRIPTION OF THE DRAWINGS

FIG. 1 shows a partial section of a high-pressure plunger pump in a longitudinal sectional view;

FIG. 2 shows a partial section of the illustration in FIG. 1 in an enlarged view;

FIG. 3 shows a schematic diagram of the high-pressure plunger pump;

FIG. 4 shows a functional measurement sheet of high-pressure plunger pump.

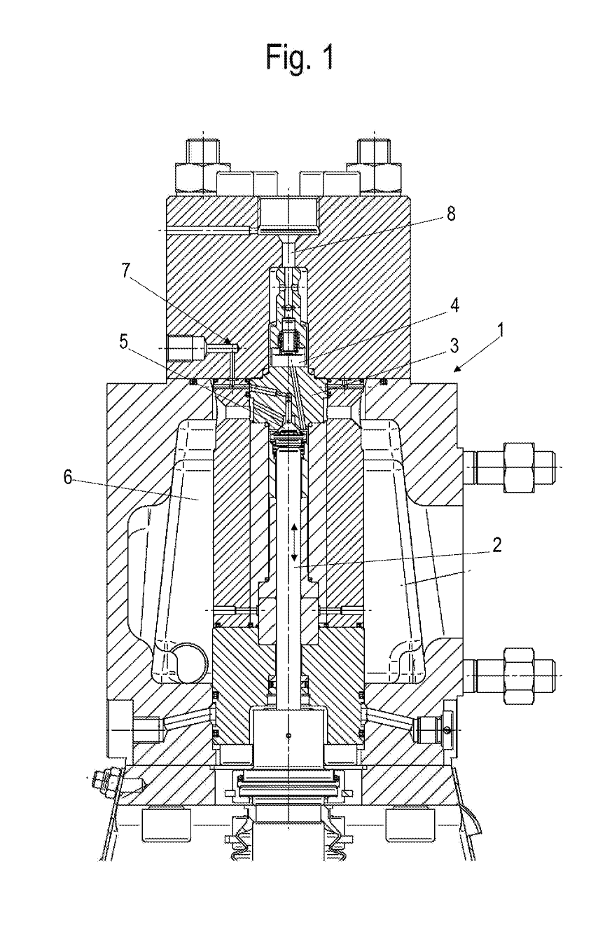

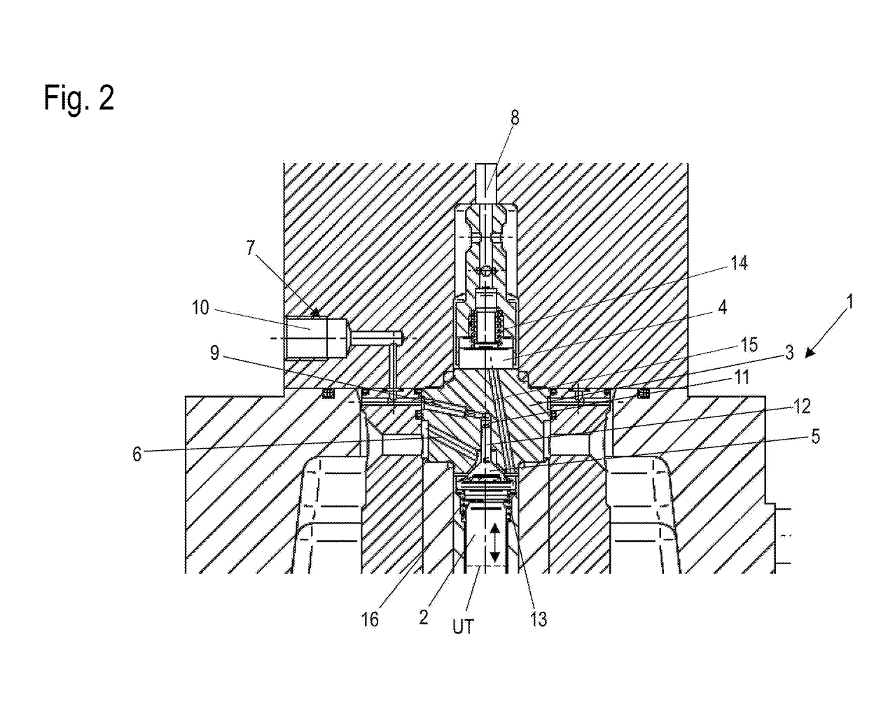

In FIGS. 1 and 2, a head portion of a high-pressure plunger pump 21 is shown, having a plunger arrangement 1, which has a working space 16 connected to a valve seat suction line 6 and a valve seat pressure line 15, in which a plunger 2 is arranged axially movable back and forth, according to the arrow in FIGS. 1 and 2.

The valve seat pressure line 15 can be closed by a pressure valve 4 and the valve seat suction line 6 by a suction valve 5, wherein the suction valve 5 can be kept in an open position in a controlled manner as required by means of a counter-pressure device 7.

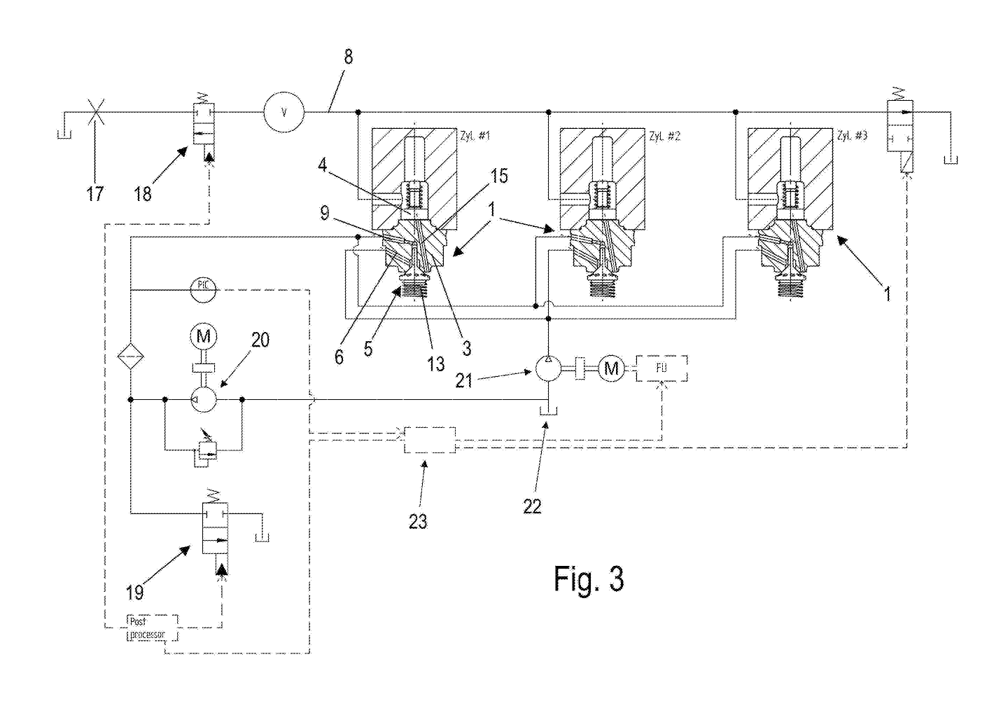

As shown, the counter-pressure device 7 comprises a supply line 9, which is in connection via a connecting line 10 with a low-pressure pump 20 (FIG. 3), via which a control fluid can be guided to the suction valve 5, wherein the connecting line 10 extends between the valve seat suction line 6 and the pressure valve.

The suction valve 5 has a valve cone which sits close in a spring-loaded manner in the closed position of the suction valve 5 by means of a compression spring 13 against a valve seat of a valve seat ring 3, namely on the side facing the plunger 2.

A pin 12 acting in the sense of a plunger is connected to the valve cone of the suction valve 5 on the side facing away from the plunger 2, which pin is axially displaceably guided in a concentric control channel 11 of the valve seat ring 3 and into which the supply line 9 opens, so that the supplied control fluid is applied with pressure to the end face of the pin 12. In this case, the pin 12 and the channel 11 are dimensioned so that there is a low-friction gap seal between the two.

FIG. 2 shows an enlarged detail of the plunger arrangement 1 in the region of the valve seat ring 3.

It can be recognized that the suction valve 5 is in an open position, i.e. the passage between the valve seat suction line 6 and the working space 16 is open, wherein the plunger 2 is in an upper dead center. A bottom dead center UT is indicated by dashed lines. Since the strokes of the plunger 2 are carried out continuously, the fluid is pushed back in a pressure stroke of the plunger 2 into the valve seat suction line 6 and thus into a fluid source 22 (FIG. 3).

While the suction valve 5 is open and remains open for a predetermined time via the control fluid, namely against the pressure of the compression spring 13, the pressure valve 4 closes the valve seat pressure line 15 by the fluid flow being under pressure in the pressure line 8 with the assistance of a compression spring 14.

In order to terminate the functional interruption of the fluid flow, both a control valve 19, which is visible in FIG. 3, as well as a shut-off valve 18 are opened, which is provided directly upstream of a hydraulic consumer such as a nozzle 17 in this example, so that, on the one hand, the suction valve 5 closes due to the now missing control pressure and the pressure valve 4 opens, while the pressure fluid is supplied via the valve seat pressure line 15 and a pressure line 8 to the nozzle 17.

During this so-called functional time of the fluid flow, the low-pressure pump 20 conveys pressureless into the fluid source 22 common to the high-pressure plunger pump 21.

For simultaneous switching of the control valve 19 and the shut-off valve 18, a controller 23, which is likewise recognizable in FIG. 3, is provided, which is programmable according to the intervals of the functional interruption of the fluid flow.

For functional interruption, therefore, the control valve 19 and the shut-off valve 18 are simultaneously closed, so that control fluid is conveyed via the low-pressure pump 20 into the control channel 11 and the suction valve 5 is kept open according to the closing time of the control valve 19.

In FIG. 3, three plunger arrangements 1 of the high-pressure plunger pump 21 are shown in a circuit diagram, the suction valves 5 of which are simultaneously actuatable. The plunger arrangements 1 are designed in a suitable manner so that in function the fluid pressure applied to the nozzle 17 remains the same over the entire functional duration.

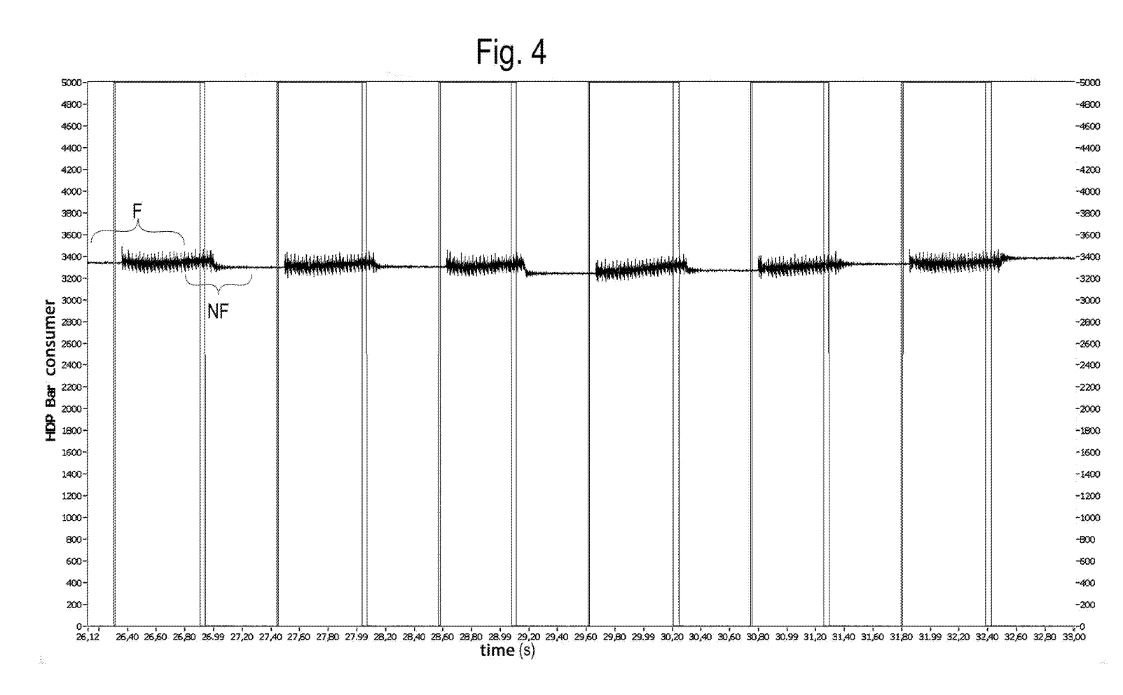

FIG. 4 shows a functional measuring sheet of the high-pressure plunger pump 21 according to the invention, wherein the operating pressure is plotted on the ordinate axis and the operating times on the abscissa axis.

The functional duration is recognizable with F, in which the fluid is applied at a pressure of about 3400 bar over a period of about 0.6 sec.

Thereafter, the function of the fluid flow is interrupted over a period NF, in which the suction valve 5 is opened.

It can be seen in FIG. 4 that the same fluid pressure is present in the time span NF in the pressure line 8 as in the functional time span F, namely approximately 3400 bar.

1. High-pressure plunger pump, having at least one plunger arrangement which has a working space connected to a valve seat suction line and a valve seat pressure line, in which a plunger is arranged in an axially reciprocable movable manner, wherein the valve seat pressure line is closeable by a pressure valve and the valve seat suction line by a suction valve, and the suction valve can be kept in an open position in a controlled manner as required by means of a counter-pressure device, wherein the counter-pressure device has a supply line via which a control fluid can be guided to the suction valve for keeping open the suction valve, wherein a low-pressure pump is connected to the supply line for generating pressure of the control fluid.

2. High-pressure plunger pump according to claim 1, wherein a control valve is provided upstream of the low pressure pump and a shut-off valve is provided upstream of a hydraulic consumer which is in connection with the valve seat pressure line, which are simultaneously closeable for the functional interruption of a fluid flow emerging from the hydraulic consumer.

3. High-pressure plunger pump according to claim 1, wherein the control valve and the shut-off valve can be actuated via a preferably programmable controller.

4. High-pressure plunger pump according to claim 1, wherein the suction side of the low-pressure pump and the suction side of the high-pressure plunger pump are connected to a common fluid source.

5. High-pressure plunger pump according to claim 1, wherein the supply line opens into a control channel in which a pin of the suction valve is guided axially displaceable, wherein the control fluid is applied with low pressure to the free end face of the pin acting as a plunger.

6. High-pressure plunger pump according to claim 1, wherein the pressure force of the control fluid is greater than the spring force of a compression spring, with which the suction valve can be pressed against a valve seat.

7. High-pressure plunger pump according to claim 1, wherein a gap seal is formed between the pin and the wall of the channel.

8. High-pressure plunger pump according to claim 1, wherein the supply line, the control channel, the valve seat suction line and the valve seat pressure line are provided in a valve seat ring, wherein the suction valve can be applied in a spring-loaded manner to the valve seat ring on the side facing the associated plunger and the pressure valve on the opposite side.

9. Method for functionally interrupting a fluid flow emerging from a hydraulic consumer of a high-pressure plunger pump, in which an axially movable suction valve is kept in an open position in a controlled manner as required and independently of the position of the associated plunger, wherein the suction valve is held hydraulically in the open position which is controlled as required.

10. Method according to claim 9, wherein a fluid similar to a pressure fluid is used as a control fluid.

11. Method according to claim 9, wherein the control fluid and the pressure fluid are drawn from a common fluid source.

12. Method according to claim 9, wherein during the functional interruption a nozzle supply line is closed on the one hand by the pressure valve and on the other hand by a shut-off valve associated with a hydraulic consumer, e.g. a nozzle, while maintaining the working pressure.

13. Method according to claim 9, wherein a control valve, with which a control fluid acting on the suction valve can be activated, and the shut-off valve are closed simultaneously during the functional interruption of the fluid flow and remain closed.

14. Method according to claim 9, wherein when arranging a plurality of suction valves each associated with a plunger, these are simultaneously brought to and held in an open position for functional interruption of the fluid flow and remain closed.
